(19) United States
(12) Patent Application Publication
(10) Pub. No.: US 2005/0021646 A1
(43) Pub. Date: Jan. 27, 2005

(54) E-mail based decision process in a hierarchical organization

(75) Inventor: Ankesh Kumar, Palo Alto, CA (US)

Correspondence Address: Steven M. Haas, Esq.;Fay, Sharpe, Fagan, Minnich & McKee, LLP, Seventh Floor, 1100 Superior Avenue, Cleveland, OH, 44114-2579, US

(73) Assignee: APPMAIL LLC

(21) Appl. No.: 10/862,727

(22) Filed: Jun. 7, 2004

Related U.S. Application Data
(63) Continuation-in-part of application No. 10/307,188, filed on Nov. 29, 2002.
(60) Provisional application No. 60/333,705, filed on Nov. 28, 2001.

(51) Int. Cl. G06F 15/16

(52) U.S. Cl. 709/206

(57) ABSTRACT

A process includes sending a request appmail to a requesting user by e-mail. The request appmail includes data input fields where the requesting user enters a request to be reviewed by a supervisor. A completed request appmail is received from the requesting user via e-mail. The request input data are extracted from the completed request appmail and are saved. An approval appmail is generated based upon and including the extracted request input data. The approval appmail is sent to the supervisor via e-mail. A completed approval appmail is received from the supervisor via e-mail. The approval input data are extracted from the completed approval appmail. Either an acceptance e-mail or a rejection e-mail is generated and sent to the requesting user depending upon the extracted approval input data. The method is also used to implement a survey or questionnaire and/or for task management.

### CROSS-REFERENCE TO RELATED APPLICATIONS

This application is a continuation-in-part of co-pending U.S. application Ser. No. 10/307,188 filed Nov. 29, 2002 which claims benefit of the filing date of and priority from U.S. provisional application No. 60/333,705 filed Nov. 28, 2001, and both application Ser. No. 10/307,188 and 60/333,705 are hereby expressly incorporated by reference into this specification.

### BACKGROUND OF THE INVENTION

The present invention relates to an e-mail based decision process and system in a hierarchical organization. It is described herein with reference to employee personal time-off management, but is suitable for use in connection with any business process that requires implementation of a hierarchical decision process or collection of structured response data from a plurality of computer users for purpose of a survey or task management. Other examples include expense management, procurement, budgeting, questionnaires, surveys and task management. For purposes of this document, a hierarchical decision process in one in which members of a hierarchy must request and receive approval from a superior member of the hierarchy in order to complete a task. Often, the requesting member and the superior member must each record data related to the request and/or approval (or rejection) of same and use the recorded data to create a report at a later date. The invention is implemental via electronic mail (e-mail) using a specialized e-mail referred to herein as an APPMAIL.

As noted, to facilitate an understanding of the present invention only and without intending to limit the invention in any way, the system and method are described herein with reference to employee personal time-off management, which requires implementation of a classic hierarchical decision process. Personal time-off is a necessary benefit that companies provide to employees. The process of requesting, editing, recording and storing personal time-off data is cumbersome and costly. Most companies rely on a paper-based system and/or an intranet-based system. These have been deemed deficient for a wide variety of reasons, most of which relate to inconvenience and the need for employees to deviate from their standard workplace routine to complete paper forms or visit an intranet website to submit required information and/or receive approval. As such, a need has been identified for an improved personal time-off management system.

The present invention provides an e-mail based system to interface with the relevant members of the personal time-off request/approval hierarchy and with any associated software application or data to provide an e-mail based decision process. The ubiquitous nature of e-mail ensures acceptance of the system by all involved. E-mail is pervasive and used by nearly all corporate computer users. Also, e-mail is available to many computer users through mobile devices such as wireless telephones, wireless personal digital assistants and portable computers. As such, the present invention is superior to paper-based and intranet-based systems.

### SUMMARY OF THE INVENTION

In accordance with a first aspect of the present development, a computer-implemented decision process in a hierarchical organization comprises sending a request appmail to a requesting user by e-mail. The request appmail comprises a plurality of data input fields by which said requesting user can enter a request to be reviewed by a supervisor member of a hierarchy. A completed request appmail is received from said requesting user via e-mail. The completed request appmail is defined by said request appmail combined with request input data entered by said requesting user into said request appmail in order to define the request. The request input data are extracted from the completed request appmail and are saved in a request database. An approval appmail is generated based upon and including the extracted request input data. The approval appmail is sent to the supervisor via e-mail. A completed approval appmail is received from the supervisor via e-mail. The completed approval appmail is defined by the approval appmail combined with approval input data entered by the supervisor into the approval appmail in order to approve or reject the request. The approval input data are extracted from the completed approval appmail. Either an acceptance e-mail or a rejection e-mail is generated and sent to the requesting user depending upon the extracted approval input data.

In accordance with another aspect of the present development, a computer-implemented method for implementing a survey is defined. The method comprises generating a first e-mail that comprises a request for information and a structured data input field comprising a finite plurality of predefined and individually selectable input values that are responsive to the request for information. The first e-mail is sent to at least one computer user. A second e-mail is received from the at least one user. The second e-mail comprises a copy of the first e-mail and further comprises a structured input value. The structured input value comprises a select one of the plurality of predefined selectable input values. The structured input value is extracted from the second e-mail. The extracted structured input value is stored in a database.

### BRIEF DESCRIPTION OF THE DRAWINGS

The present invention comprises various systems and methods, preferred embodiments of which are illustrated in the accompanying drawings that form a part hereof and wherein:

FIG. 1 is a diagrammatic illustration of a system formed in accordance with the present invention;

FIG. 2 is a flow chart that illustrates a process for initiating a time off request or a similar hierarchical request in accordance with the present invention;

FIG. 3 illustrates a specialized e-mail (referred to herein as an “APPMAIL”) generated in accordance with the present invention according to the initiation process of FIG. 2 and including both structured and unstructured input fields and output fields for a user to provide input to and receive output from an underlying basic computer software application and other users;

FIG. 4 is a flow chart that illustrates a process for preparing/submitting a time off request or a similar hierarchical request implemented in accordance with the present invention using the APPMAIL of FIG. 3;

FIG. 5 is a flow chart that discloses a process for approving/rejecting a request submitted in accordance with FIG. 4 using an APPMAIL;

FIG. 6 illustrates an APPMAIL by which the process of FIG. 5 is implemented;

FIG. 7 discloses a process for capturing/reporting time off or another hierarchical reporting parameter in accordance with the present invention;

FIGS. 8 and 9 are appmails for implementing portions of the process of FIG. 7;

FIG. 10 illustrates a spreadsheet output by the process of FIG. 7;

FIG. 10A illustrates a time-off amnesty appmail used on a one-time basis as part of a setup process; and,

FIG. 11 is a diagram that generally illustrates the process of generating and using an APPMAIL in accordance with the present invention.

### DETAILED DESCRIPTION OF THE INVENTION

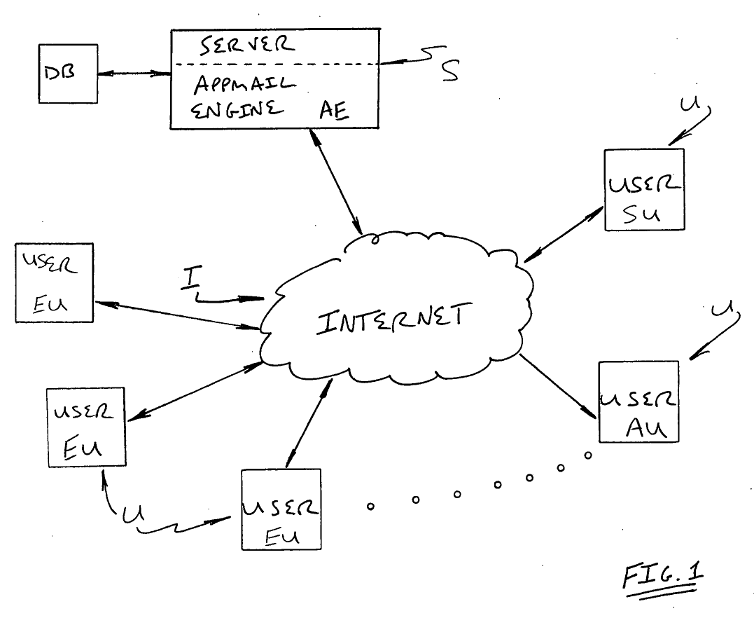

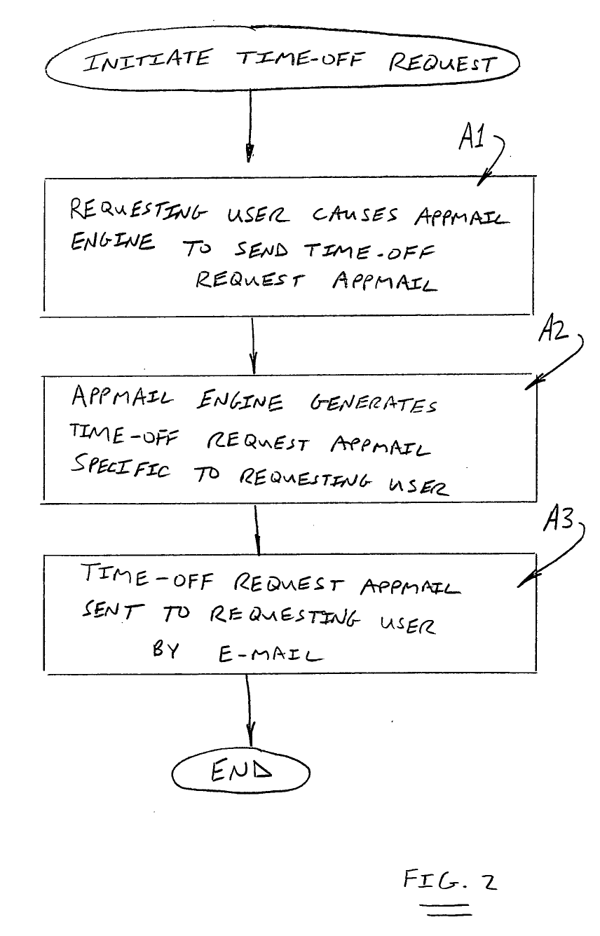

FIG. 1 diagrammatically illustrates a conventional web-based computer system for multiple computers or other electronic devices (e.g., web-enabled telephones, etc.) U to send data to and receive data from a server S (that comprises one or more computers) via the internet I or another computer network. The user devices U are connected to the internet or other network via wired or wireless connection. The server S comprises or is connected to database system DB that stores and allows authorized user devices U to obtain controlled/structured access to vast amounts of data as is also well-known in the art. In accordance with the present invention, however, the server S is programmed to implement a novel and unobvious computer software application, referred to herein as the appmail engine AE, that provides a system and method for an e-mail based decision process in a hierarchical organization.

For purposes of understanding the system and method of the present invention, the invention is described with reference to a personal time-off management software application incorporating or interfacing with an appmail engine AE. In this manner, the invention is described with reference to real-world examples that facilitate an understanding of the inventive concepts. The appmail engine AE can be used as described herein in connection with any other software application (referred to herein as the “basic application” or “basic program”) where multiple members of a business or other hierarchy are seeking to interact with each other in a structured fashion to ensure that requests are approved or disapproved and recorded in a timely and easily understood fashion, with required record keeping.

In accordance with the present development, the server S is running a basic application (the personal time-off management system in the present example) that incorporates or interfaces with the appmail engine AE. The user devices U are each allowed a level of access with respect to the server S and basic application depending upon the authority assigned to the human user of those devices U. The human user of a user device U can be an e-mail user EU that interacts with the basic application only via e-mail only through the appmail engine AE; a standard user SU who has all rights of an e-mail user but can also access the server S and use basic application directly through a web browser or otherwise to control the basic application (and consequently the appmail engine); or an administrative user AU that has all the rights and privileges of a standard user SU, but can also add/delete standard users and also can access certain restricted, administrative portions of the basic application. As described hereinbelow, the system and method of the present invention allow the e-mail users EU and all other users to initiate and/or participate in a decision process as part of a hierarchical organization, even though these e-mail users EU cannot directly access and use the basic application running on server S.

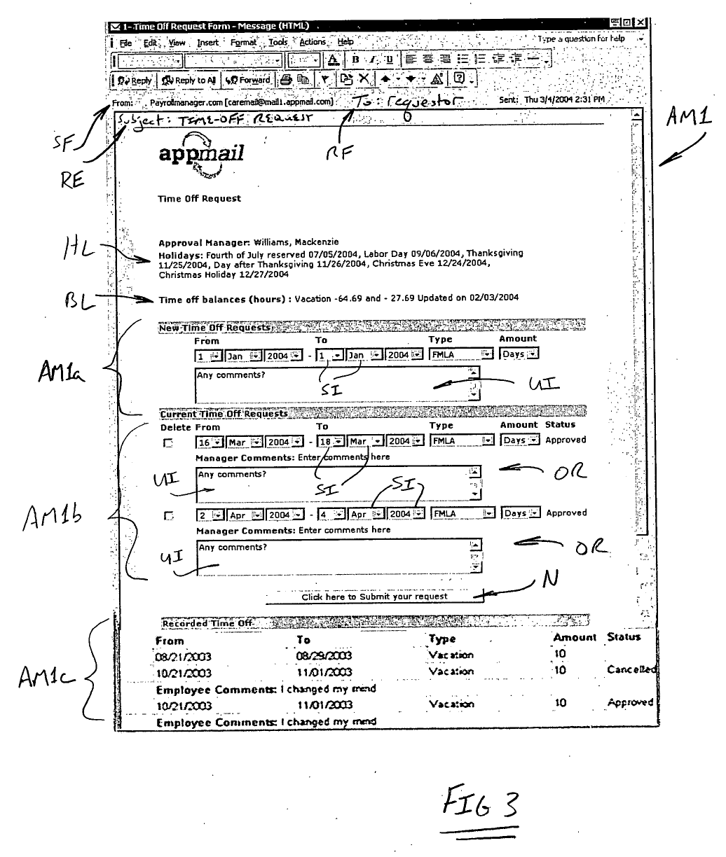

FIG. 2 illustrates a process by which a user U (typically an email user EU), referred to herein as the “requesting user,” initiates an e-mail based decision process according to the present invention. In a step A1, the requesting user causes the appmail engine AE to send him/her a time-off request appmail. In one preferred embodiment, the requesting user accomplishes the step A1 by sending an e-mail to the basic application running on server S via predetermined e-mail address, e.g., “request@timeoff.com” or directly to the appmail engine. The basic application is then able to determine the identity of the requesting user based upon requesting user's e-mail address, e.g., by accessing a user database portion of the database DB, and submit same to the appmail engine AE as input, along with other data as described below.

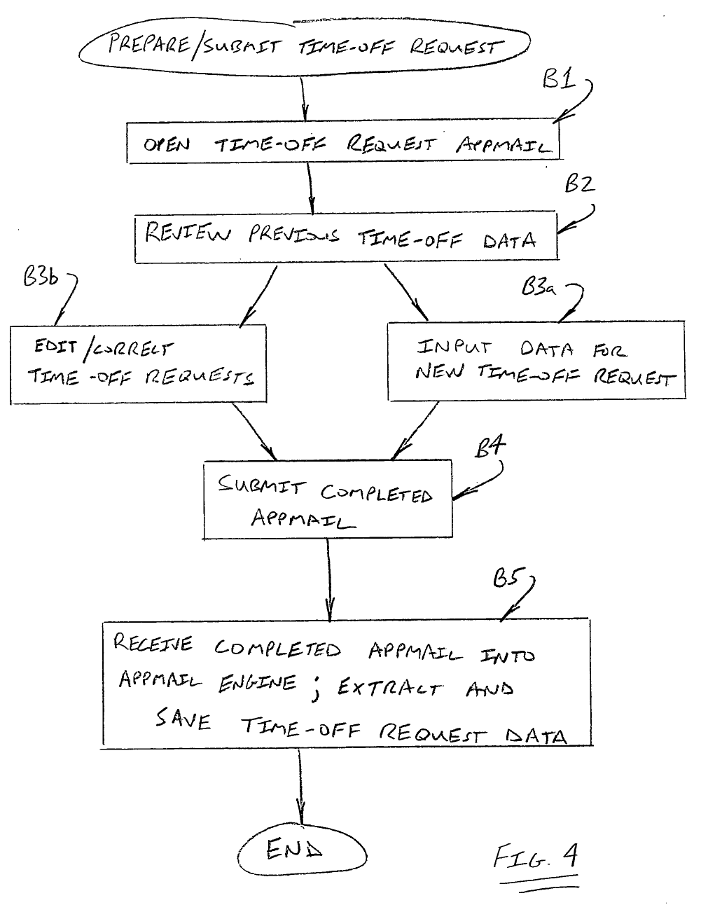

In a step A2 the appmail engine AE generates a time-off request appmail (shown at AM1 in FIG. 3) that is specific to the requesting user as described in further detail below.

In a step A3, the time-off request appmail is sent from the server to the requesting user via e-mail.

The time-off request appmail AM1 is shown in FIG. 3 in the form of a screen print. The appmail AM1 comprises a web page embedded within or defining an e-mail message. Typically, an appmail such as the time-off request appmail AM1 is implemented as an MHTML or HTML e-mail file and provides output information to the recipient and receives input information from the recipient. Preferably, an appmail defined in accordance with the present invention includes: (i) at least one structured input field that requires a user to select one of a plurality of predetermined inputs; and, (ii) at least one unstructured input field that allows a user to enter free-form text or other data as desired.

With specific reference to the time-off request appmail AM1 shown in FIG. 3, it comprises a header including a sender field SF identifying the sender, a recipient field RF identifying at least one recipient, and a reference field RE identifying a subject. The appmail engine AE or basic application running on the server optionally “spoofs” the sender field SF when the appmail is created so that it includes a name/e-mail address that is familiar to the requesting user, e.g., the supervisor of the requesting user. The time-off request appmail AM1 further comprises a “New Time Off Requests” section AM1a that comprises multiple structured input fields SI, in the form of pull-down menus, radio buttons and/or other predefined selectable input fields, by which the requesting user can select desired predefined structured input data from finite possibilities to define a new time-off request, including start or “from” date, end or “to” date, type of time-off (e.g., bereavement, jury duty, sick leave, unpaid, vacation, family medical leave act (FMLA)), and the total number of days. The New Time Off Requests section AM1a further comprises at least one unstructured input field UI into which the requesting user can type any required text comments/explanation. The time-off request appmail AM1 preferably further comprises a send field N that, when selected, sends the appmail AM1 and all structured/unstructured data input inserted by the requesting user (referred to herein as the “completed appmail”), to the server S and appmail engine AE for further processing according to the present invention.

Preferably the time-off request appmail AM1 comprises additional sections that provide useful information and features to the requesting user. As shown in FIG. 3, the time-off request appmail further comprises an open request section such as a “Current Time Off Requests” section Am1b that allows the requesting user to edit/delete any previously submitted time-off requests, if not yet actually used/completed. As such, the “Current Time Off Requests” section sets forth the details of all open time-off requests OR for the requesting user, and allows the user to edit same via structured input fields SI or delete same by selecting the “delete” structured input field. The edited/deleted request is then re-submitted via e-mail when the requesting user selects submit field N.

The time-off request appmail AM1 further comprises a previous request section such as a “Recorded Time Off” section AM1c that includes multiple output fields that provide a summary of each time-off request associated with the requesting user. As shown in correspondingly labeled fields, each time-off request is described in terms of its start “from” and end “to” dates, type, amount of days, and status (e.g., approved, completed, cancelled), and any unstructured input comments entered by the requesting user (referred to as “Employee Comments” in the illustrated example appmail AM1) when submitting the request. The time-off request appmail AM1 preferably includes a request balance field that sets forth a remaining request balance from an initial request allowance. An example of this feature is shown herein via time-off balance output field BL that sets forth the vacation and/or other type of time-off balance data remaining for the requesting user, and preferably also includes a holiday output field HL listing holiday time-off on a company-wide basis and/or tailored to the requesting user.

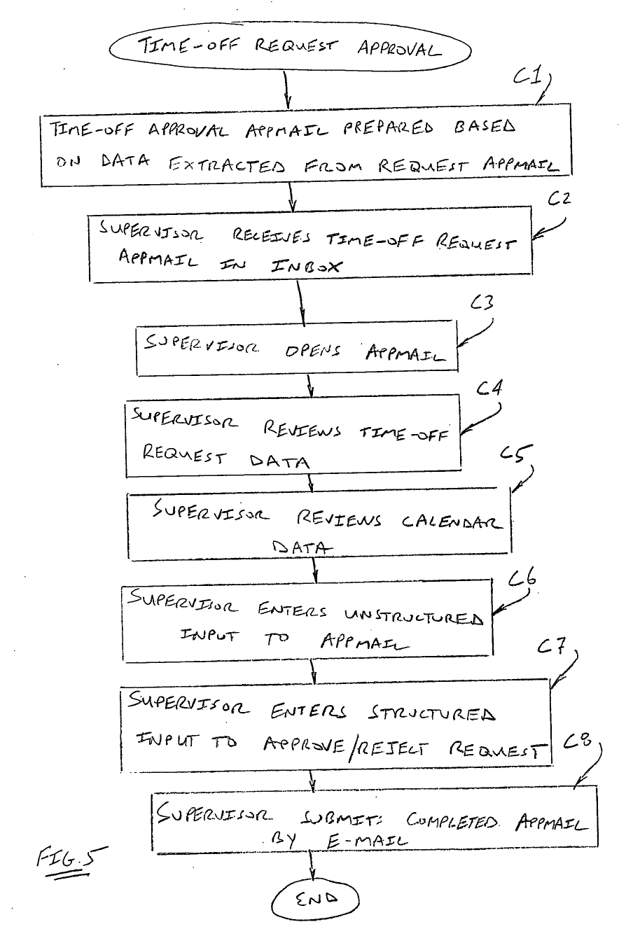

FIG. 4 is a flow chart that discloses a process by which a requesting user prepares and submits the time-off request appmail AM1. In a step B1, the user opens the time-off request appmail AM1 using his/her e-mail program. In a step B2, the user reviews his/her previous time-off data using the “Recorded Time Off” section AM1c and the remaining balance output field BL to determine a time-off balance remaining from his/her total time-off allowance. In a step B3a the user inputs data that describe a new time-off request in the section AM1a via structured and unstructured input fields SI,UI. It is most preferred that the request appmail AM1 comprise a plurality of structured input data fields SI that, taken together, completely define the request so that use of unstructured input field UI is optional. As an alternative or in addition to the step B3a, the user completes step B3b by inputting data in the section AM1b that edit or delete a current time-off request via structured input fields SI and, optionally, unstructured input fields UI. Whether the user implements step B3a or step B3b, in step B4 the user selects the submit field N so that the completed appmail AM1 (including all data input by the user) is sent via e-mail to appmail engine for extraction of the data input by user for use by the basic program.

In a step B5, the appmail engine AE receives the completed appmail AM1 and extracts the structured and unstructured (if any) input data from fields SI,UI. The appmail engine AE saves the extracted response data to a request database such as a time-off database DB (FIG. 1) utilized by the basic application via server S. This, then, allows for the extracted structured input data to be easily processed according to standard database processing methods for any desired purpose such as reviewing the data, searching the data, generating reports/statistics based upon the data, inputting the data to another application, using the data within the appmail engine AE to populate fields of a new appmail template, etc. The unstructured input text data are saved in the database DB for later inclusion in other appmails and/or reports as described herein.

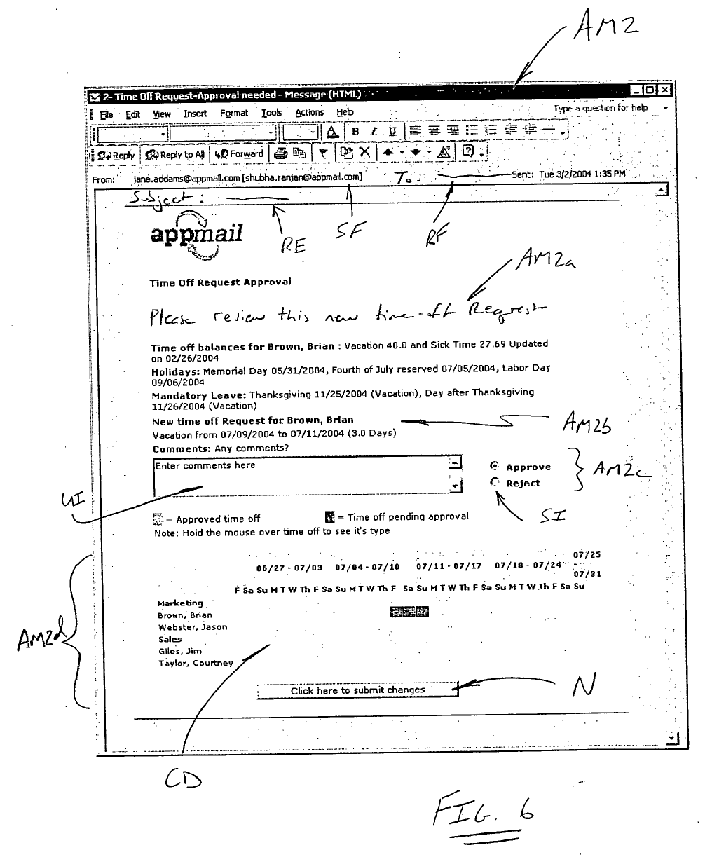

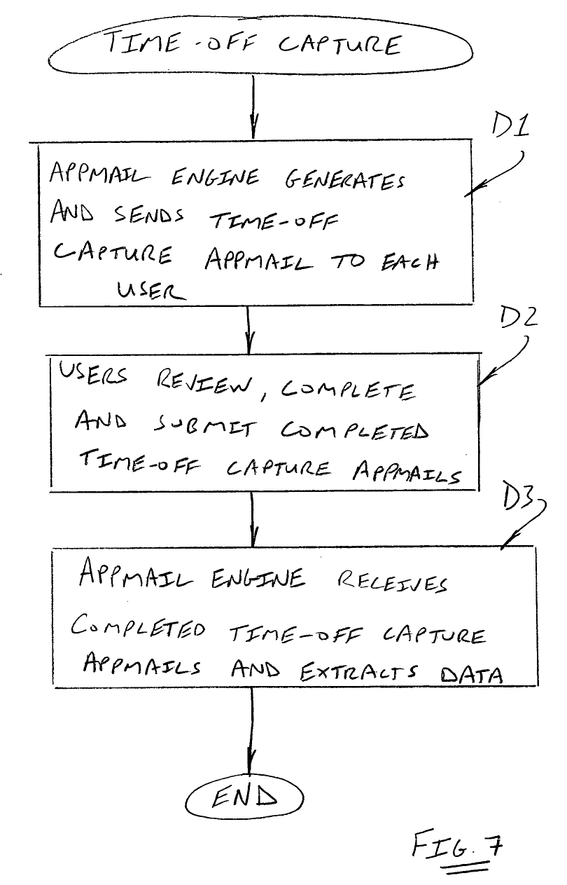

FIG. 5 illustrates a time-off request approval process implemented as part of an e-mail based decision process in accordance with the present invention. In a step C1, the appmail engine AE prepares a time-off request approval appmail AM2 (see FIG. 6) based upon the completed time-off request appmail AM1 submitted by the requesting user as described above. Preferably, when the requesting user submits a completed time-off request appmail AM1, the appmail engine AE uses same as a signal to initiate generation of the time-off request approval appmail AM2 automatically, without further human intervention.

Referring briefly to FIG. 6, the time-off request approval appmail AM2 also preferably comprises a header including a sender field SF identifying the sender, a recipient field RF identifying at least one recipient, and a reference field RE identifying a subject. The appmail engine AE or basic application running on the server optionally “spoofs” the sender field SF when the appmail is created so that it includes the name/e-mail address of the requesting user or other select information. The time-off approval appmail AM2 further comprises a message section AM2a that includes a text message requesting review of a time-off request. The appmail AM2 further comprises a request detail section AM2b comprising all data that describe the new time-off request including: name of requesting user, dates of requested time-off and total number of days, any comments entered by the requesting user in the unstructured input section UI of the appmail AM1. The data used to populate the request detail section AM2b are retrieved by the appmail engine AE from the database DB, in particular, from the user database and request database portions thereof. The appmail AM2 further comprises an input section AM2c comprising at least one structured input field SI by which the supervisor can select either “approve” or “reject” responses. The input section AM2c preferably also comprises an unstructured input field UI by which the supervisor can enter any desired text that he/she desires to be communicated to the requesting user. The appmail AM2 preferably also comprises a submit field N that is selectable by the supervisor to submit the completed appmail AM2, included all structured and any unstructured data entered in fields SI,UI, to the appmail engine AE.

It is also preferable that the Time-Off Request Approval appmail AM2 include a related request section that allows the supervisor to review requests that are related to the current request. In the illustrated embodiment, this is provided by a calendar output section AM2d comprising calendar data CD that graphically define a select calendar time period, e.g., four weeks. The calendar output section AM2d further comprises name data that described the names of all people reporting to the supervisor and who have requested time off during the time period represented by the calendar data. The calendar time period associated with each person is color-coded or otherwise coded to indicate the time-off days requested by each person and whether or not the requested days have been approved. As such, the supervisor reviewing the Time-Off Request Approval appmail AM2 can determine whether the time-off request of the requesting user conflicts with another time-off request as represented by the calendar data CD.

Referring again to FIG. 5, the Time-Off Request Approval process further comprises a step C2 where the supervisor receives the Time-Off Request Approval appmail AM2 via e-mail, and a step C3 where the supervisor opens the appmail AM2 using his/her e-mail program or browser. In a step C4, the supervisor reviews the new time off request data AM2b as set forth in the appmail AM2. In a step C5, the supervisor reviews the calendar output section AM2d including calendar data CD relating to other approved/unapproved time-off requests. In optional step C6, the supervisor enters text in the unstructured input section UI of the appmail AM2. In a step C7, the supervisor approves or rejects the time-off request represented by the appmail AM2 using the structured input fields SI, e.g., by selecting the “accept” radio button RB1 or the “reject” radio button RB2 (FIG. 6). In a step C8, the supervisor selects the submit field N to send the completed appmail AM2 (including all his/her inputs thereto) via e-mail to the appmail engine AE.

The appmail engine AE receives the completed Time-Off Request Approval appmail AM2 and parses same to extract data from the structured input fields SI and any data input by the supervisor in the unstructured input fields UI and saves all extracted data in the database DB. If the supervisor entered structured input in the field SI of the appmail AM2 that indicates the time-off request was rejected, the appmail engine AE automatically generates a “rejection” email and sends same to the requesting user to inform him/her of the rejection. If the supervisor entered structured input in the field SI of the appmail AM2 that indicates the time-off request was approved, the appmail engine AE automatically generates an “approved” e-mail and sends same to the requesting user to indicate that the request has been granted. The “approved” e-mail preferably includes an update for the requesting user's calendar that describes the approved time-off request and that populates the calendar (e.g., Outlook) with the approved time-off dates.

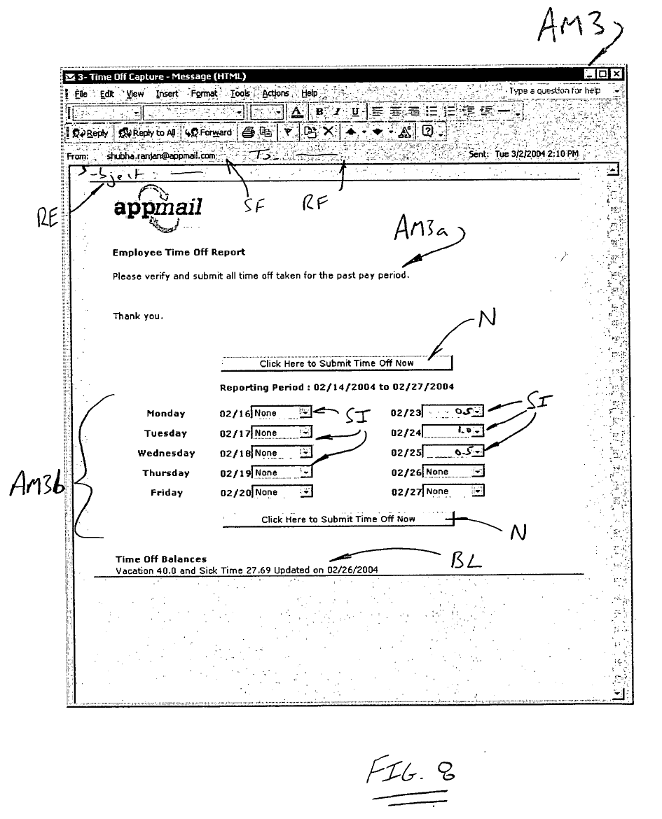

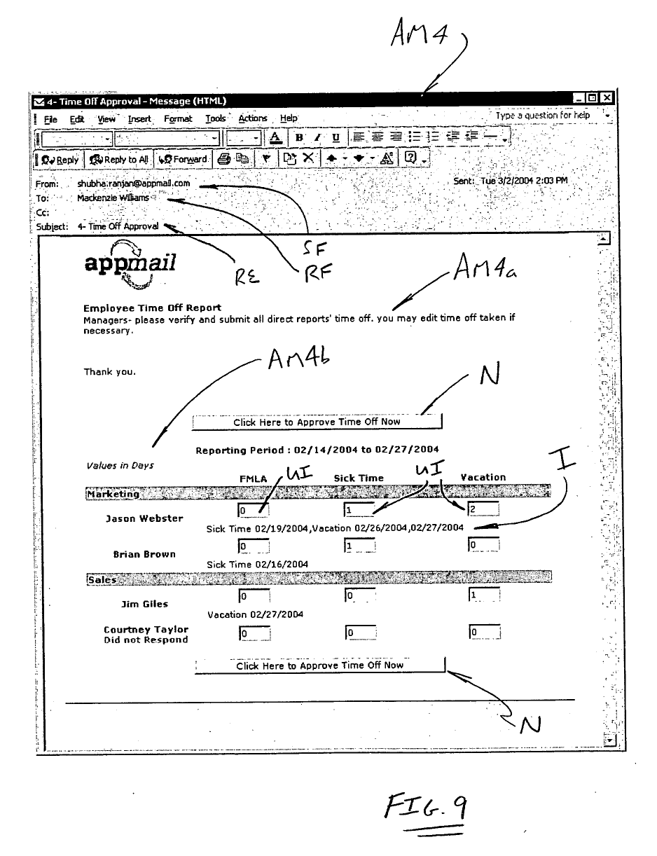

The present development provides a method and apparatus for implementation of a survey or questionnaire and/or for take management. One example of this is shown in FIG. 7 which discloses a time-off capture process that facilitates capture of unreported/unapproved time-off and confirmation of approved time-off to minimize payroll and other mistakes. In a step D1, the appmail engine AE generates and sends by e-mail a time-off capture e-mail that is specific to each user U. An example of a time-off capture appmail AM3 is shown in FIG. 8. There, it can been seen that the time-off capture appmail comprises the header data described above, i.e., sender data SF, recipient data RF, subject data RE, and also a time-off capture text message AM3a directed to the user and requesting confirmation/correction of approved time-off and entry of any unapproved time-off, such as an unplanned sick day. The appmail AM3 further comprises a time-off balance output section BL as described above to provide the user with his/her remaining time-off balance. The appmail AM3 also includes a time-off capture section AM3b that comprises a textual/graphic listing of all days in the pay period and a structured input field SI associated with each day. In one example, the choices “None” “0.5” and “1.0” are used as the predefined data selections for the structured input fields SI to indicate no time-off, a half-day off and a full-day off, respectively. Also, the structured input field SI associated with an approved time-off request is pre-populated with the amount of approved time-off. Referring to the example shown in FIG. 8, the structured input fields SI associated with the dates of February 23-25 are pre-populated with the structured input values “0.5,” “1.0,” and “0.5,” respectively, because the user in receipt of the time-off capture appmail AM3 previously requested and received approval for a half day off on February 23 and 25, and a full day off on February 24. As shown at step D2 in FIG. 7, using the time-off capture appmail AM3, the user controls the structured input field SI associated with each day of the pay period to enter additional time-off and/or to correct the pre-populated entries, e.g., if approved time-off was not actually used or if more or less time was used as compared to the amount approved. The user then selects one of the submit fields N to submit the completed appmail AM3 to the appmail engine AE.

In a step D3, the appmail engine AE received the submitted time-off capture appmails and extracts the structured input from fields SI. The extracted data are saved in the database DB.

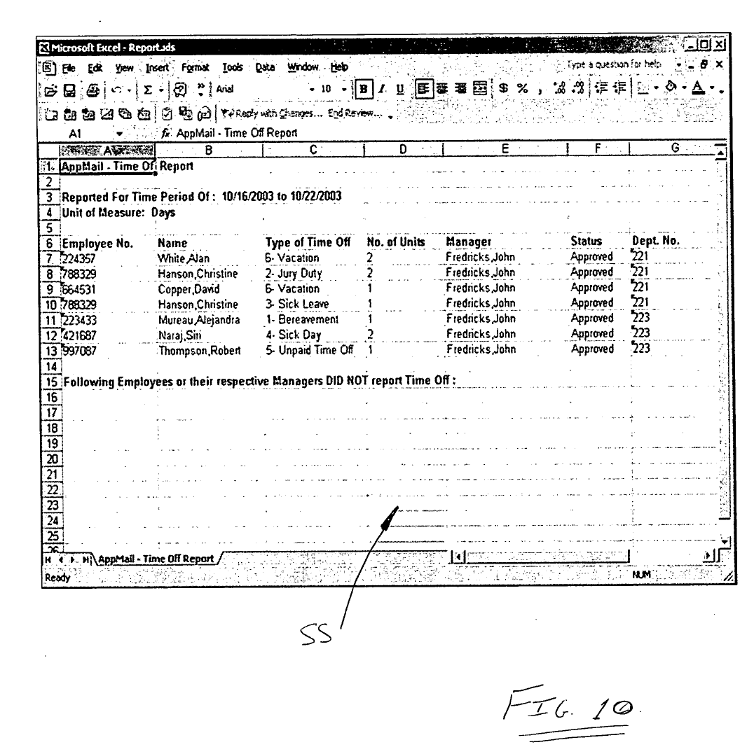

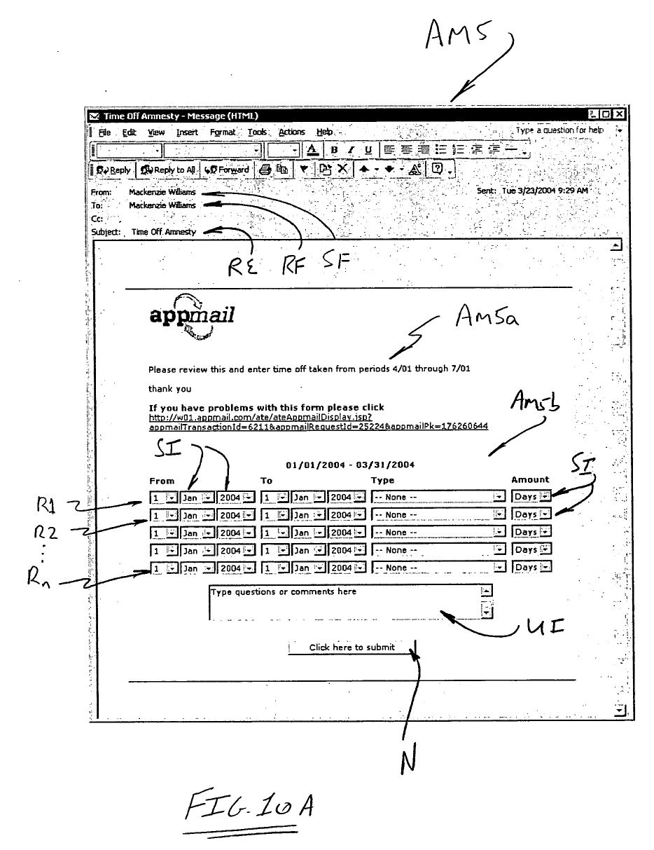

FIG. 9 illustrates another example of a appmail used as a task management tool. In particular, a time-off report appmail AM4 is generated by the appmail engine AE and sent to all users U (i.e., supervisors/managers) within a hierarchical organization who are responsible for tracking and reporting time-off incurred by users (employees) in lower levels of the hierarchy. The time-off report appmail comprises the above-described header data SF,RF,RE and also includes an text field AM4a that presents textual instructions to the recipient. The time-off report appmail AM4 further comprises a time-off report section AM4b. In a preferred embodiment, the time-off report section AM4b is customized for each supervisor/manager user U in receipt thereof so that only the direct-report employees of the supervisor/manager will be listed therein. This customization is implemented by the appmail engine AE according to data stored in database DB or elsewhere concerning the structure and members of the hierarchy. At least one unstructured data input field UI is associated with each employee user listed in the time-off report section AM4b. In the example shown in FIG. 9, multiple unstructured data input fields UI are associated with each listed employee user, with each field related to a particular type of time-off (and is labeled accordingly). As is also shown in FIG. 9, the data input fields UI for each listed employee user are preferably pre-populated by the appmail engine AE, using data retrieved from the database DB, with the amount of time-off incurred by the employee during the pay period. In the example of FIG. 9, the amount of time-off incurred is specified for each type of time-off for which an unstructured data filed UI is provided. Furthermore, for each listed employee with non-zero time-off data, the appmail AM4 comprises a text information field I that specifies the type and dates of incurred time-off. The supervisor/manager recipient of the time-off report appmail AM4 reviews the pre-populated data for each listed employee and corrects errors or omissions, if any. The supervisor/manager then selects one of the submit fields N to return the time-off report appmail AM4 to the appmail engine AE via e-mail, where the time-off data from the unstructured input fields UI are extracted and saved in the database DB. The finalized time-off report data saved in database DB are usable for any desired purpose, such as for calculating pay checks and the like. As shown in FIG. 10, the data stored in database DB are saved in conventional formats to allow for retrieval of the data and presentation of same in a standard spreadsheet format SS or the like as desired.

A further example of use of the present development as a survey/questionnaire and task management tool is shown in FIG. 10A which illustrates a time-off amnesty appmail AM5 that can be used on a one-time basis as a setup to the launch of the above-described system/method in order to capture employee time-off incurred prior to the launch date. The time-off amnesty appmail AM5 is sent to all employees who are required to report time-off via e-mail. The appmail includes the header information SF,RF,RE and a text portion AM5a that provides instruction and explanation to the recipient. The appmail AM5 also comprises a time-off entry portion AM5b including a plurality of time-off records R1,R2, . . . Rn, each of which comprises multiple structured input fields that allow the recipient to enter time-off incurred by selecting the start and end dates, type, and amount from the structured input choices. The recipient submits the completed appmail AM5 to the appmail engine AE by selecting the submit field N. The appmail engine AE extracts the structured input data from fields SI and stores the data in the database DB for each reporting employee.

Those of ordinary skill in the art will realize from the foregoing that the use of appmails such as the appmails AM1,AM2,AM3,AM4,AM5 allow a user U (even an e-mail only user) of system S to initiate and/or participate in a decision process in a hierarchical organization via e-mail. The use of appmails AM1,AM2,AM3,AM4,AM5 as described facilitates collection of structured and unstructured input from users U and allows for extraction of same from completed appmails for use of the data in a subsequent process or report.

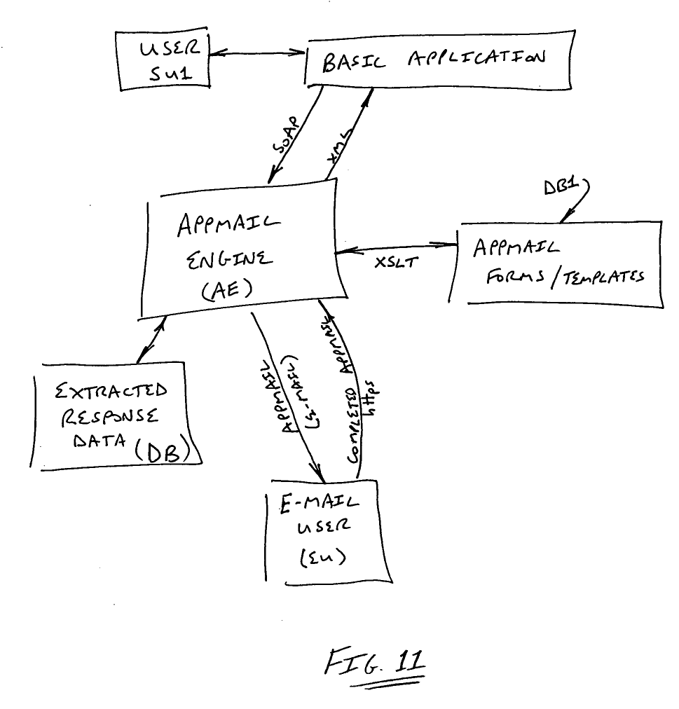

FIG. 11 is a diagram that generally illustrates the process of generating and using an appmail in accordance with the present invention. The appmail engine AE receives a request for a new appmail, either from the basic application or via direct input from a user, e.g., as by step A1 of FIG. 2 where a user sends an e-mail request to the appmail engine, directly or through the basic application (it is noted again that the appmail engine AE can be integrated into the basic application or separate). The request for an appmail includes any required data to be inserted into a predefined appmail template and/or includes data that are used by the appmail engine AE to access the database DB (e.g., the user database and request database portions thereof) for retrieval of the required data to populate the appmail being constructed so as to include the requesting user's name and/or e-mail address, supervisor's name, holiday output field HL, time-off balance field BL, the “Current Time-Off Requests” section AM1b, and the “Recorded Time-Off” section AM1c, all of which data is stored in the database DB. For example, in the case of step A1 of FIG. 2, where a user sends an e-mail to the appmail engine AE to request a time-off request appmail AM1, the appmail engine AE uses the sender's e-mail address to determine which records to access in the database DB in order to populate a generic template for the appmail AM1 with the noted information.

The predefined appmail templates and/or rules are stored in an appmail template database such as the database DB or another database such as DB1 in FIG. 11. The appmail engine AE prepares the requested appmail by combining the user-supplied data, if any, with the data retrieved from the database DB and the corresponding predefined appmail template/rules. As noted, the appmail engine preferably spoofs the “From” field of the appmail being constructed so that the appmail will appear to a recipient user as having been sent by a particular user (e.g., a supervisor) instead of the appmail engine AE.

Once the appmail is constructed, the appmail engine AE sends same to the requesting user U via e-mail. The recipient user will open the appmail via browser, e-mail program, etc. and will provide the requested structured and unstructured response data in the fields SI,UI based upon the content of the appmail or other information. The completed appmail is then sent from the user U back to the appmail engine AE by standard e-mail paths or by http(s) or other secure or non-secure means. The appmail engine AE then extracts the structured and unstructured response data from fields SI,UI and stores same in the database DB for storage and use as described above.

With continuing reference to FIG. 11, in the illustrated embodiment, the appmail engine AE stores the appmail forms/templates as XSLT based data. The appmail engine AE receives a request for an APPMAIL through the underlying basic application, based upon a direct user request or as an automatic request based upon user submission of another appmail (e.g., user submission of a time-off request appmail AM1). If the appmail request is sent via the basic application, the basic application generates a SOAP message that contains a transaction which includes one or more appmail requests. Each APPMAIL request is a set of XML data defined by the requesting user using the underlying basic application program. The SOAP message includes additional data to define the desired appmail transaction such as, e.g., a due date for responses from recipients of the appmail, the definition of a valid response (e.g., whether an incomplete response is valid), the percentage of valid responses required, and other parameters such as what action to take (e.g., re-send, none) in the event an invalid completed appmail is received. The SOAP message defining the requested appmail transaction further preferably includes re-send instructions defined by the requesting user that indicate when an appmail should be re-sent by the appmail engine AE to a recipient (and how many re-send attempts are to be made) upon a recipient's failure to respond to the original appmail. The appmail engine AE logs the overall transaction and all requests included therein in a database DB.

Each XML request defined as part of the SOAP message received by the appmail engine AE is translated into the required appmail. More particularly, the appmail engine AE integrates the XML request data from the SOAP message with the appropriate XSLT-based appmail form/template that was previously stored by the appmail engine AE in the database DB1. The resulting appmail is preferably defined as an MHTML (or HTML) email, and the engine AE sends the appmail to the designated recipients via e-mail.

As described above, the recipients of the appmail complete the appmail by entering structured and optional unstructured data and return the completed appmail to the appmail engine via http/https to an awaiting servlet. The appmail engine AE receives the completed appmail and re-constitutes same into XML. The XML data representing structured and unstructured response data entered by the recipient of the APPMAIL and other associated data are stored in the database DB and logged against the relevant request from which the appmail was generated.

It should also be apparent from the foregoing description that the present development is effective to distribute and collect answers to questionnaires and surveys, and is also used as a task management tool. In this case, an appmail is generated and sent to one or more recipients. The appmail includes questions or other requests for information intended for the recipient. The appmail comprises one or more structured input fields by which the recipient responds to the questions or other requests for information. The appmail can also comprise an unstructured input field to receive text data as typed therein by the recipient. The completed appmail is returned via e-mail to the appmail engine, where the structured/unstructured input data are extracted and saved in a database for later use as desired in compiling questionnaire/survey responses or for task management purposes.

It should be noted that the various databases described herein can be defined as separate databases or be combined into a single database without departing from the overall scope and intent of the present development.

The invention has been described with reference to preferred embodiments. Modifications to the invention will occur to those of ordinary skill in the art upon reading this specification. It is intended that the appended claims be construed literally and/or according to the doctrine of equivalents as including all such modifications and alterations.

1. A computer-implemented decision process in a hierarchical organization, said process comprising:
sending a request appmail to a requesting user by e-mail, said request appmail comprising a plurality of data input fields by which said requesting user can enter a request to be reviewed by a supervisor member of a hierarchy;
receiving a completed request appmail from said requesting user via e-mail, said completed request appmail defined by said request appmail combined with request input data entered by said requesting user into said request appmail in order to define said request;
extracting said request input data from said completed request appmail and saving said extracted request input data in a request database;
generating an approval appmail based upon and including said extracted request input data;
sending said approval appmail to said supervisor via e-mail;
receiving a completed approval appmail from said supervisor via, e-mail, said completed approval appmail defined by said approval appmail combined with approval input data entered by said supervisor into said approval appmail in order to approve or reject said request;
extracting said approval input data from said completed approval appmail; and,
generating and sending to said requesting user an acceptance e-mail or a rejection e-mail depending upon said extracted approval input data.

2. The computer-implemented decision process as set forth in claim 1, wherein said step of sending a request appmail to a requesting user comprises:
receiving an e-mail from said requesting user via an e-mail address of said requesting user;
determining an identity of said requesting user based upon said e-mail address of said requesting user;
accessing at least one of said user database and said request database to retrieve user data specific to said user based upon said identity;
accessing a appmail template database to retrieve data that define a request appmail template; and,
populating said request appmail template with said user data.

3. The computer-implemented decision process of claim 2, wherein said user data define at least one prior request submitted by said user to said supervisor and wherein said user data comprise data that define a request balance remaining for said user from an initial request allowance.

4. The computer-implemented decision process as set forth in claim 2, wherein said data that define said request appmail template comprise XLST data.

5. The computer-implemented decision process as set forth in claim 4, wherein said request appmail comprises header data comprising:
recipient data that identify said e-mail address of said requesting user; and,
spoofed sender data that identify an e-mail address of said supervisor.

6. The computer-implemented decision process as set forth in claim 5, wherein said request appmail comprises at least one structured input data field by which said requesting user inputs said request input data to define said request, wherein each structured input data field comprises a plurality of input data choices that are individually selectable by said requesting user to define said request.

7. The computer-implemented decision process as set forth in claim 6, wherein said at least one structured input data field comprises multiple separate structured input data fields that completely describe said request.

8. The computer-implemented decision process as set forth in claim 7, wherein said request appmail further comprises an unstructured input data field into which said requesting user enters text data related to said request.

9. The computer-implemented decision process as set forth in claim 6, wherein said step of generating said approval appmail comprises:
accessing said appmail template database to retrieve data that define a approval appmail template;
accessing said request database to retrieve said request input data; and,
populating said request approval appmail template with said request input data to define a request detail section of said approval appmail that describes said request.

10. The computer-implemented decision process as set forth in claim 9, wherein said step of generating said approval appmail further comprises:
accessing said request database to retrieve request data for related requests that are associated with said request;
populating a related request section of said approval appmail with said related request data to provide information that describes said related requests.

11. The computer-implemented decision process as set forth in claim 10, wherein said request approval appmail comprises at least a structured input data field by which said supervisor can select one of an approve input field to indicate approval of said request or a reject input field to indicate rejection of said request.

12. A computer-implemented method for implementing a survey, said method comprising:
generating a first e-mail that comprises a request for information and a structured data input field comprising a finite plurality of predefined and individually selectable input values that are responsive to said request for information;
sending said first e-mail to at least one computer user;
receiving a second e-mail from said at least one user, said second e-mail comprising a copy of said first e-mail and further comprising a structured input value, said structured input value comprising a select one of said plurality of predefined selectable input values;
extracting said structured input value from said second e-mail;
storing said extracted structured input value in a database.
